(19) United States
(12) Patent Application Publication
(10) Pub. No.: US 2026/0134149 A1
(43) Pub. Date: May 14, 2026

(54) METHOD FOR CROSS NON-COOPERATIVE DOMAIN IDENTITY AUTHENTICATION

(71) Applicant: Beijing University of Posts and Telecommunications, Beiing (CN)

(72) Inventors: Jianfeng Guan, Beijing (CN); Su Yao, Beijing (CN); Shujie Yang, Beijing (CN); Kexian Liu, Beijing (CN); Xiaolong Hu, Ji 'an (CN); Jianli Liu, Longyan (CN); Ye Qin, Changde (CN)

(21) Appl. No.: 19/371,504

(22) Filed: Oct. 28, 2025

(30) Foreign Application Priority Data
Nov. 14, 2024 (CN) 202411626585.8

(51) Int. Cl. G06F 21/62; G06F 21/64; H04L 9/08; H04L 9/32; H04L 9/40

(52) U.S. Cl. CPC G06F 21/6254; G06F 21/64; H04L 9/0833; H04L 9/3236; H04L 9/40

(57) ABSTRACT

A method for cross-non-cooperative domain identity authentication is provided. The method includes: utilizing routers in a core network to negotiate symmetric keys and global group keys to complete system initialization; performing user identity registration through a registration server, generating digital identity identifiers, anonymized identity identifiers, and MAC address lists, and establishing mapping relationships; users negotiating symmetric keys with adjacent routers and associating with MAC address lists; users encrypting anonymized identity identifiers based on address hopping engines and symmetric keys, embedding into data packet source IP addresses, randomly selecting MAC addresses as source MAC addresses, calculating integrity check codes, and completing data packet construction; uploading data packets to routers and performing intra-cooperative domain authentication and cross non-cooperative domain authentication. The disclosure strongly binds user identity information with source addresses, simultaneously achieving source address verification and identity authentication, considers privacy protection from multiple angles, including link addresses and network addresses, without introducing new identifiers, supports cross non-cooperative domain scenarios, and is applicable to different scenarios.

### TECHNICAL FIELD

The disclosure relates to the field of network security technology, and more particularly to a method for cross non-cooperative domain identity authentication.

### BACKGROUND

With the rapid advancement of computer technology, an increasing number of users are joining the Internet. These users can be subdivided into different groups based on the range of resources they can access and the services they utilize, thereby defining their user identities. As the number of users increases, identity authentication and authorization technologies for network access will face significant challenges. It is necessary not only to ensure secure and trustworthy verification services for user identity information but also to ensure that resource access restriction permissions are only granted to legitimate users who have passed identity authentication, preventing third-party attackers or other unauthorized users from bypassing the verification mechanism to obtain network resources and services. For example, attackers may steal authenticated user identity information to conduct unauthorized network communications. Therefore, ensuring the privacy and security of authenticated users within the system is essential. Address hopping has emerged as a solution to this issue. An ideal address-hopping system can trace each data packet back to its sender, but at the same time, the sender's identity itself and the transmitted content need privacy protection. Therefore, constructing a unified and reliable identity verification and privacy protection scheme is essential. A sound identity verification system can effectively prevent unauthorized access and identity theft, ensuring the security of sensitive data. In terms of user experience, seamless authentication mechanisms such as Single Sign-On (SSO) allow users to access multiple applications without providing identity credentials again after one authentication by the authentication server, reducing the user operation burden without compromising security. The existing technology has the following deficiencies:
(1) Source address verification does not consider privacy protection: Data collected during the source address verification process may not be properly encrypted and protected, which increases the risk of data leakage. If this data falls into the hands of malicious third-party attackers, user privacy may be seriously threatened.
(2) New identifiers introduced for privacy protection reduce deployability. Although common address-hopping schemes protect user privacy, the process of introducing new identifiers requires a series of changes to existing Internet infrastructure and protocols. This includes not only updates to the hardware and software of network devices such as routers and switches, but may also involve large-scale modifications to DNS, routing protocols, and various network management and security protocols. These changes require the participation and cooperation of multiple parties, such as network operators and standardization organizations, to ensure that new identifiers can be applied in current networks.
(3) Privacy protection is not thorough enough: Although measures have been taken to protect IP address privacy, existing mechanisms are not comprehensive because they only focus on anonymity at the network layer without extending to MAC address protection at the link layer. In certain attack scenarios, attackers can still track and identify users through MAC addresses in data packets.
(4) Does not support cross-domain scenarios involving non-cooperative domains. Non-cooperative domains are autonomous network domains that operate independently and do not collaborate with other domains, unlike cooperative domains. Specific systems or services are usually deployed within cooperative domains, and various nodes within cooperative domains can coordinate their work to achieve the expected functions of the system. In non-cooperative domains, these systems or services are not deployed, and nodes within non-cooperative domains neither participate in nor cooperate with operations or behaviors in cooperative domains. When data packets with address hopping need to cross non-cooperative domains where the above systems are not deployed during transmission, they may not be correctly routed to designated hosts in another cooperative domain.

### SUMMARY

The purpose of the disclosure is to provide a method for cross non-cooperative domain identity authentication to solve the aforementioned problems existing in the prior art.

To achieve the above purpose, the disclosure provides a method for cross-non-cooperative domain identity authentication. The method includes:
step S1: utilizing adjacent routers within the same autonomous domain in a core network to negotiate first symmetric keys for each router and corresponding MAC address lists, utilizing boundary routers within each cooperative domain in the core network to negotiate global group keys, and completing system initialization.
step S2: after system initialization is completed, performing validity verification on network-accessing users sending identity registration requests through a registration server in the core network; after verification passes, utilizing the registration server to generate digital identity identifiers and anonymized identity identifiers corresponding to the network-accessing users, and configuring MAC address lists for the network-accessing users; utilizing the registration server to construct mapping relationships among the digital identity identifiers, anonymized identity identifiers, and the MAC address lists, saving the constructed mapping relationships to distributed infrastructure in the core network and sending them to the network-accessing users, completing user identity registration;
step S3: after user identity registration is completed, the network-accessing users perform symmetric key negotiation with adjacent routers within the corresponding autonomous domain to generate second symmetric keys, and associate the second symmetric keys with the MAC address lists of the network-accessing users.
step S4: after association is completed, the network-accessing users obtain MAC information of adjacent nodes based on a neighbor discovery protocol, determine third symmetric keys based on the obtained MAC information, encrypt the anonymized identity identifiers using an address hopping engine in the network-accessing users combined with the third symmetric keys to obtain privacy information and embed the privacy information into source IP addresses of data packets, randomly select MAC addresses from the MAC address lists of the network-accessing users as source MAC addresses of the data packets, calculate integrity check codes of the data packets through hash algorithms, and embed the integrity check codes into the data packets, completing construction of the data packets;
step S5: upload the data packets to various routers in the core network, performing intra-cooperative domain authentication and cross non-cooperative domain authentication on the data packets during the uploading process.

Optionally, the negotiation process of the first symmetric keys for each router and corresponding MAC address lists (the step S1) specifically comprises:
step S11: negotiating the first symmetric keys between adjacent routers within the same autonomous domain through secure channels and key exchange protocols;
step S12: after negotiation of the first symmetric keys is completed, each router saves the first symmetric keys and the corresponding MAC address lists.

Optionally, after system initialization is completed, performing validity verification on network-accessing users sending identity registration requests through the registration server in the core network (the step S2) specifically comprises:
step S21: The network-accessing users submitting identity information to the registration server through a secure channel for identity registration; utilizing the registration server to verify the identity validity of the network-accessing users; when duplicate registration exists, the identity information is invalid, and the registration request is rejected.
step S22: if duplicate registration does not exist, the identity information is valid; utilizing the registration server to generate digital identity identifiers and anonymized identity identifiers corresponding to the network-accessing users, and configuring MAC address lists for each interface of the network-accessing user devices.

Optionally, encrypting the anonymized identity identifiers using the address hopping engine in the network-accessing users, combined with the third symmetric keys, is specifically calculated by the formula:

$$( EID ‖ AVD ) = {E}_{SK} ( AID ‖ TS ‖ {IP}_{dst} )$$

Where EID is Embedded Identifier, AVD is Additional Validation Data, AID is anonymized identity identifier, TS is timestamp, IP_{dst} is destination network layer IP address, E_{SK} is symmetric key encryption algorithm using SK key.

Optionally, calculating the integrity check codes of the data packets through hash algorithms specifically comprises:

Obtaining the integrity check codes of the data packets based on link addresses, network addresses, additional information, and payloads of the data packets, combined with hash operations.

Optionally, the authentication process of the intra-cooperative domain authentication (the step S5) specifically comprises:
step S51: when a router within a single cooperative domain receives the data packet, performing integrity verification on the integrity check code of the data packet; after integrity verification passes, finding the corresponding third symmetric key according to the source MAC address of the data packet; if the third symmetric key is not found, sending error information to the distributed infrastructure; if the third symmetric key is found, decrypting the anonymized identity identifier and destination IP address based on the obtained third symmetric key, comparing the destination IP address of the data packet with the decrypted IP address, and utilizing the distributed infrastructure to perform authenticity verification on the decrypted anonymized identity identifier and corresponding source IP address; if the destination IP address is inconsistent or the anonymized identity identifier cannot be queried in the distributed infrastructure, discarding the data packet and reporting malicious information; if the destination IP address is consistent and the anonymized identity identifier is queried in the distributed infrastructure, passing authenticity verification and completing identity authentication.

Optionally, performing integrity verification on the integrity check code of the data packet specifically comprises:

Calculating a current integrity check code of the data packet based on hash operations; if the current integrity check code is consistent with an original integrity check code of the data packet, passing integrity verification; if the current integrity check code is inconsistent with the original integrity check code of the data packet, discarding the data packet.

Optionally, the authentication process of the cross non-cooperative domain authentication (the step S5) specifically comprises:
step S52: when the data packet traverses from a source cooperative domain through several non-cooperative domains and finally arrives at a destination cooperative domain, utilizing the global group key to encrypt user identity information to obtain privacy information and embed the privacy information into the source IP address of the data packet, randomly selecting a MAC address from the MAC address list of the network-accessing user as the source MAC address of the data packet, calculating the integrity check code of the data packet through hash algorithms, and embedding the integrity check code into the data packet, uploading the data packet to the non-cooperative domain;
step S53: when the destination cooperative domain receives the data packet, performing integrity verification on the integrity check code of the data packet; after integrity verification passes, finding the corresponding global group key according to the source MAC address of the data packet; if the global group key is not found, sending error information to the distributed infrastructure; if the global group key is found, decrypting the anonymized identity identifier and destination IP address based on the obtained global group key, comparing the destination IP address of the data packet with the decrypted IP address, and utilizing the distributed infrastructure to perform authenticity verification on the decrypted anonymized identity identifier and corresponding source IP address; if the destination IP address is inconsistent or the anonymized identity identifier cannot be queried in the distributed infrastructure, discarding the data packet and reporting malicious information; if the destination IP address is consistent and the anonymized identity identifier is queried in the distributed infrastructure, passing authenticity verification and completing identity authentication.

### BRIEF DESCRIPTION OF DRAWINGS

To more clearly illustrate the technical solutions in the embodiments of the disclosure or in the prior art, the following briefly introduces the drawings required for use in the embodiments. Obviously, the drawings in the following description represent only some embodiments of the disclosure. Those skilled in the art can derive other drawings based on these without requiring creative effort.

The illustrative embodiments of the disclosure and their descriptions are used to explain the disclosure and do not constitute improper limitations on the disclosure. In the drawings:

FIG. 1 is an example diagram within a single cooperative domain in an e mbodiment of the disclosure.

FIG. 2 is an example diagram illustrating cross-cooperative domain com munication in an embodiment of the disclosure.

FIG. 3 is an example diagram of an embodiment of the disclosure in whic h an attacker forges identity information.

FIG. 4 is an example diagram when an attacker tampers with data packets in an embodiment of the disclosure;

FIG. 5 is an authentication flowchart illustrating an embodiment of the di sclosure.

### DETAILED DESCRIPTION OF EMBODIMENTS

Various exemplary embodiments of the disclosure are described in detail below. This detailed description should not be considered as limiting the disclosure but should be understood as providing a more comprehensive explanation of certain aspects, characteristics, and implementations of the disclosure.

It should be understood that the terminology used in the disclosure is merely for describing particular embodiments and is not intended to limit the disclosure. Additionally, for numerical ranges in the disclosure, it should be understood that each intermediate value between the upper and lower limits of the range is also specifically disclosed. Intermediate values within any stated value or stated range and every smaller range between any other stated value or intermediate value within said range are also included within the disclosure. The upper and lower limits of these smaller ranges may independently be included or excluded from the range.

Unless otherwise indicated, all technical and scientific terms used herein have the same meanings as commonly understood by one of ordinary skill in the art to which this disclosure pertains. Although the disclosure describes only preferred methods, any methods similar or equivalent to those described herein may also be used in the practice or testing of the disclosure. All documents mentioned in this specification are incorporated by reference for the purpose of disclosing and describing methods related to such documents. In case of conflict with any incorporated document, the content of this specification shall prevail.

Various improvements and changes may be made to the specific embodiments of the disclosure specification without departing from the scope or spirit of the disclosure, which would be obvious to those skilled in the art. Other embodiments obtained from the specification of the disclosure would be obvious to those skilled in the art. The specification and examples of this disclosure are exemplary only.

The terms “comprising,” “including,” “having,” “containing,” etc., used herein are all open-ended terms, meaning including but not limited to.

It should be noted that, in the absence of conflict, the embodiments in this disclosure and the features in the embodiments may be combined with each other. The disclosure will be described in detail below with reference to the drawings and in combination with the embodiments.

### Embodiment 1

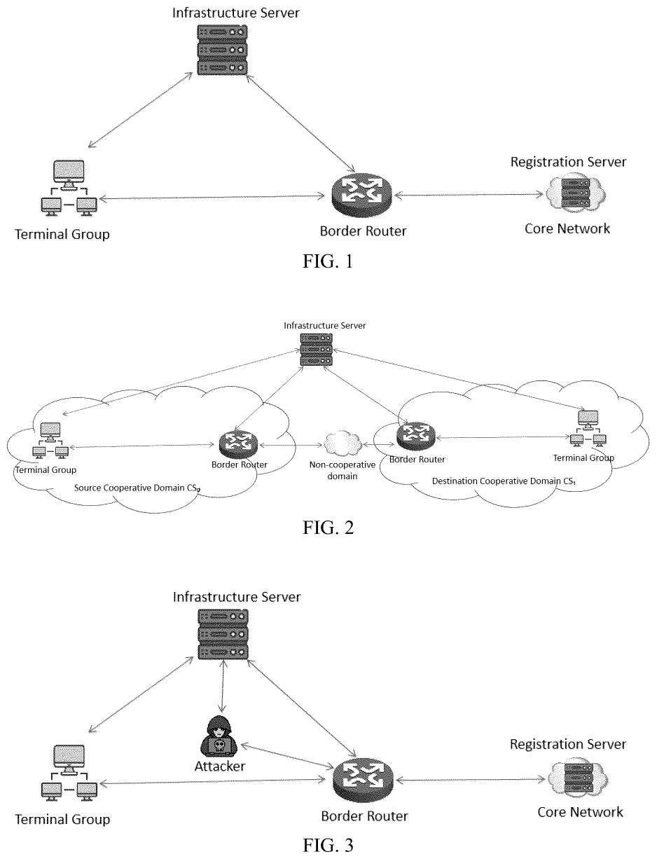

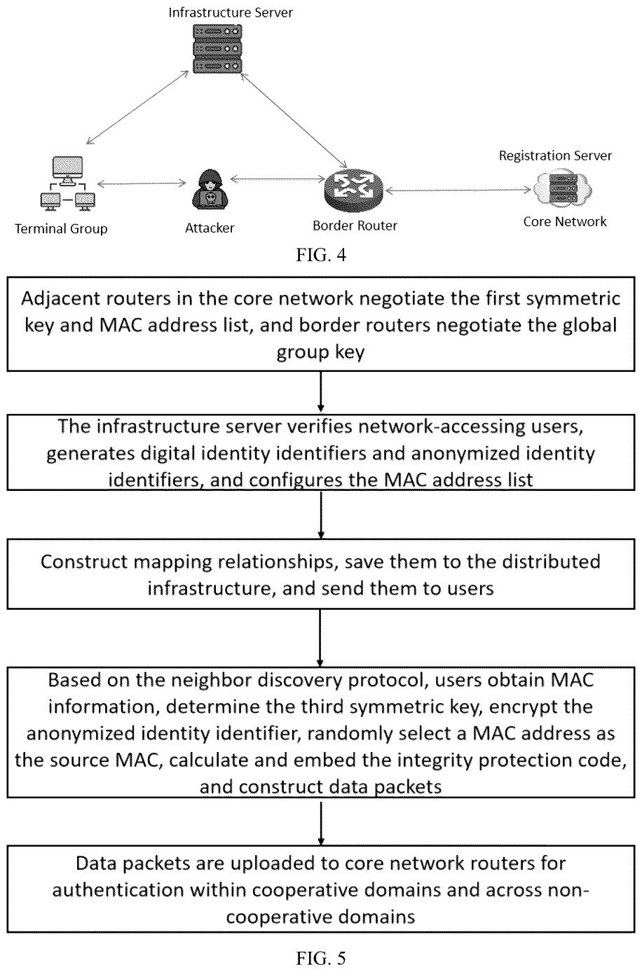

As shown in FIGS. 1-5, this embodiment provides a method for cross non-cooperative domain identity authentication, comprising:
Step 1: Utilizing adjacent routers within the same autonomous domain in a core network to negotiate first symmetric keys for each router and corresponding MAC address lists, utilizing boundary routers within each cooperative domain in the core network to negotiate global group keys, and completing system initialization.
Step 2: after system initialization is completed, performing validity verification on network-accessing users sending identity registration requests through a registration server in the core network; after verification passes, utilizing the registration server to generate digital identity identifiers and anonymized identity identifiers corresponding to the network-accessing users, and configuring MAC address lists for the network-accessing users; utilizing the registration server to construct mapping relationships among the digital identity identifiers, anonymized identity identifiers, and the MAC address lists, saving the constructed mapping relationships to distributed infrastructure in the core network and sending them to the network-accessing users, completing user identity registration;
Step 3: after user identity registration is completed, the network-accessin g users perform symmetric key negotiation with adjacent routers within the corre sponding autonomous domain to generate second symmetric keys, and associate the second symmetric keys with the MAC address lists of the network-accessing users.
Step 4: after association is completed, the network-accessing users obtain MAC information of adjacent nodes based on a neighbor discovery protocol, determine third symmetric keys based on the obtained MAC information, encrypt the anonymized identity identifiers using an address hopping engine in the network-accessing users combined with the third symmetric keys to obtain privacy information and embed the privacy information into source IP addresses of data packets, randomly select MAC addresses from the MAC address lists of the network-accessing users as source MAC addresses of the data packets, calculate integrity check codes of the data packets through hash algorithms, and embed the integrity check codes into the data packets, completing construction of the data packets;
Step 5: upload the data packets to various routers in the core network, performing intra-cooperative domain authentication and cross non-cooperative domain authentication on the data packets during the uploading process.

Existing address-hopping authentication schemes have some unresolved problems, such as difficulty in deployment on existing network architectures after introducing new identifiers, insufficient privacy protection, and inapplicability to cross non-cooperative domain scenarios.

To address the above problems, this embodiment proposes the following solutions:
First, design a lightweight address tag framework that modifies link-layer addresses and network-layer addresses. After obtaining hopping parameters from the registration management server, the hopping engine performs anonymization processing and generates new network layer addresses and link layer addresses, achieving a strong binding relationship between user identity information and source addresses, ensuring identity privacy of data packets during network transmission. Then, after decrypting the identity information carried in the source network layer address of the data packet through symmetric key algorithms, authentication confirmation is performed by distributed infrastructure servers, simultaneously achieving source address verification and identity authentication. Next, hash algorithms are used for data packet integrity verification to promptly detect tampering of data packets by third-party attackers during transmission.
Second, propose using global group keys to encrypt the identity information of exit routers in cooperative domains in cross non-cooperative domain scenarios, carrying it by data packets to entry routers of another cooperative domain for decryption, achieving cross non-cooperative domain communication.

In summary, this embodiment introduces address hopping into the identity authentication system, achieving a strong binding relationship between source addresses and user identities, and realizing source address identity authentication. This embodiment designs a lightweight address tag framework that completes authentication and identity privacy protection during network transmission through network layer address and link layer address hopping, and uses integrity verification and distributed infrastructure servers for authentication confirmation, meeting the security and reliability requirements of data. This scheme uses group keys when crossing non-cooperative domains, achieving secure communication between different cooperative domains, ensuring data transmission security while considering the practicality of network communication.

This embodiment is applicable to various industries and fields that need to strengthen network security and protect identity privacy and data integrity during data transmission, including but not limited to enterprises, financial services, cloud services, the Internet of Things, government, healthcare, e-commerce, smart cities, military and defense, educational research, cross-domain communication, and mobile devices and remote work environments, with the following advantages:
(1) This embodiment strongly binds user identity information with data packet source addresses, simultaneously achieving source address verification and user identity authentication.
(2) This embodiment considers user privacy information protection from multiple perspectives, including link addresses and network addresses, and does not introduce new identifiers, thus not affecting the normal operation of existing network protocol stacks.
(3) This embodiment considers cross non-cooperative domain scenarios for source address authentication, allowing data packets carrying user privacy information to cross multiple non-cooperative domains, enabling better adaptation to different scenarios.

The authentication scheme provided in this embodiment is divided into five phases.

The first phase is the system initialization phase, in which the key negotiation process between routers is mainly executed.

The second phase is where users submit identity information to the registration server for registration and obtain legitimate user identity identifiers.

The third phase is where users who have obtained legitimate identities perform symmetric key negotiation with adjacent routers in their autonomous domain.

The fourth phase is the data packet sending phase, where the address hopping engine must perform necessary operations to make the data packet behavior comply with the authentication process.

The fifth phase is where routers verify data packet identities. This phase can be divided into two situations: the first situation is where exit routers within a single cooperative domain authenticate data packets, and successfully authenticated data packets can be sent to the external network; the second situation is cross-non-cooperative domain authentication, mainly where entry routers in other domains verify data packets.

### Phase 1: System Initialization.

In this phase, adjacent routers within the same autonomous domain need to negotiate symmetric keys in advance. The negotiation of symmetric keys requires establishing a secure channel between routers, usually generating a pair of symmetric keys through key exchange protocols such as the Diffie-Hellman algorithm without exchanging keys. The negotiation process needs to ensure the randomness and unpredictability of keys. After negotiation is completed, each router obtains symmetric keys and a group of MAC address lists (MACList) maintained by the distributed infrastructure, which are usually continuous. When data packets need to be sent for communication, communicating users will randomly select an item from the MAC address list as the source MAC address of the data packet, ensuring that the source MAC addresses of data packets sent from the same host will constantly change within a certain range. It should be noted that MACList does not necessarily consist of continuous MAC addresses, but continuous MAC addresses have relatively low maintenance difficulty. To ensure that MAC addresses used by different users do not conflict, the distributed infrastructure needs to manage and maintain the association relationship between the MACList and user devices and update them in a timely manner. Subsequently, routers maintain the mapping relationship between the peer communication entity MACList and the key.

In addition, a global group key will be negotiated among boundary routers in all cooperative domains. This key is used to establish trust relationships between different cooperative domains and is the foundation for cross-non-cooperative domain data exchange.

### Phase 2: Identity Registration Phase.

In this phase, network-accessing users submit identity information to Registration Servers (RSs) through secure channels for registration. RSs check and verify the validity of user identities, such as whether duplicate registration exists. If identity information is invalid, the registration request is rejected. If valid, RSs generate a digital identity identifier (DID) associated with the user identity for that user, and use hash functions to generate an anonymized identity identifier AID=hash (DID). To achieve link-layer address hopping, each interface of network-accessing user devices will also obtain a group of MACList. When sending data packets for communication, an item will be randomly selected from MACList as the source MAC address of the data packet. Subsequently, RSs save the {DID, AID, MACList} mapping relationship in the distributed infrastructure. To further enhance security, both AID and MACList can have expiration times, and AID and MACList are updated when security threats are detected or at the end of their lifecycle.

Finally, RSs return {DID, AID, MACList} to the registered user. When the user receives the successful registration return information, they will maintain a bidirectional mapping table between the actual IP address used and AID locally, used to restore the actual source IP of data packets.

### Phase 3: Symmetric Key Negotiation Phase.

Users who have obtained legitimate identities will perform symmetric key negotiation with adjacent routers within their autonomous domain. This process is similar to the key negotiation process between adjacent routers in the first phase, requiring users and adjacent routers to generate symmetric keys through secure channels. This key is used for subsequent encryption and decryption of identity privacy information, and only the parties participating in negotiation hold the corresponding keys. Keys negotiated between adjacent entities need to establish association relationships with the MACList of the negotiation object, with multiple MAC addresses in the MAC list mapped to that symmetric key. Through MACList-mapped symmetric keys, it is ensured that authentication-required user identity information carried in data packets can be correctly encrypted and authenticated through the correct key during source MAC address changes.

### Phase 4: Communication Initiation Phase.

Before sending data packets, user devices first obtain MAC information of adjacent nodes through the Neighbor Discovery Protocol (NDP) to determine the symmetric key SK used for this decryption based on the next-hop MAC. When the discovered next-hop MAC address cannot match any MAC address in the currently saved neighbor MACList, there can be different behaviors depending on different network functions, such as processing according to the original data packet sending process. Usually, when a neighbor's MAC address is not included in any MACList, it is considered that the current user has not completed the registration phase or symmetric key negotiation phase, and all packet sending behaviors of that user should be blocked. This is because the absence of a symmetric key means that user privacy cannot be hidden from attackers who maliciously capture the data packet through encryption and decryption. Once the data packet is transmitted on the network, even if the domain boundary gateway router does not allow the data packet to exit, it cannot guarantee that user identity information will not be leaked.

After obtaining the symmetric key SK, the address hopping engine on the user device needs to encrypt the user's AID, timestamp information, and destination IP address using symmetric key encryption to generate privacy information that can be embedded in data packets, namely (EID∥AVD)=E_{SK} (AID∥TS∥Past), where EID is Embedded Identifier, AVD is Additional Validation Data. Timestamps are used to ensure different encryption results when using the same AID, ensuring that each data packet's source IP address is different. EID will be embedded in the latter several bits of the data packet's source IP address. Usually, to satisfy the balance between network prefix and host quantity, a 64-bit length EID is adopted. The remaining part of the encryption result is AVD. The length of AVD will depend on the specific symmetric encryption algorithm and will be added to the data packet extension field along with other additional information for router identity authentication. This additional information does not contain plaintext information of user identity and is only transmitted as necessary information required for authentication. Even if attackers capture data packets, they cannot steal the privacy information of data senders through this information.

Successful embedding of EID means successful network address hopping. Next, the user device will randomly select an item from its maintained MACList as the source MAC address of the data packet and write it into the corresponding field of the data packet.

Finally, based on the data packet's link address, network address, additional information, and payload, the data packet's Integrity Checksum Code (ICC) is obtained through hash operations. Subsequently, the data packet carrying additional authentication information and ICC is sent to the network for transmission.

### Phase 5: Identity Authentication Phase.

The identity authentication phase requires routers on the data packet transmission path to verify the identity information carried by data packets. On one hand, this prevents malicious traffic from spreading on the network and affecting normal system operation; on the other hand, it checks whether user identity information has received privacy protection. The identity authentication phase is divided into the following two situations: the first situation is authentication within a single cooperative domain, mainly performed by domain boundary exit routers, and successfully authenticated data packets are allowed to enter the network; the second situation involves cross non-cooperative domains, where exit routers in the source domain and entry routers in the destination domain need to coordinate their work and jointly perform identity authentication.

Mode 1: Authentication within a Single Cooperative Domain:

When a router within a single cooperative domain receives a data packet sent by a user host, it first performs integrity verification ICC. Based on the data packet's link address, network address, additional information other than ICC, and payload, the current ICCn of the data packet is obtained through hash operations and compared with the original ICC, carried by the data packet. If the results are inconsistent, it is considered that the data packet has been maliciously tampered with by a man-in-the-middle, and the data packet should be discarded. If the results are consistent, the data packet passes integrity verification and can continue with subsequent identity authentication.

Identity authentication first needs to find the corresponding symmetric key SK based on the data packet's source MAC address. It is worth noting that the source MAC in the data packet is not the actual MAC address of the previous-hop router/user host, but rather an item randomly selected from its corresponding MACList. Since the mapping table between MACList and symmetric keys was established in advance during the system initialization and symmetric key negotiation phases, SK can still be found from the data packet's source MAC. If SK is not found, it is considered that the previous hop of the data packet transmission path used a fake MAC address or an error occurred during key negotiation, and the error situation needs to be reported to the distributed infrastructure.

After obtaining SK, it is used to decrypt the embedded EID and AVD in the data packet to obtain (AID∥TS∥IP_{dst})=D_{SK}(EID∥AVD). Then the router will first compare the destination IP address of the data packet with the decrypted IP address, and then verify the authenticity of AID through the distributed infrastructure and restore the original source IP address. Once the destination IP address is inconsistent or the user identity of AID cannot be queried from the distributed infrastructure, the data packet may have been sent by a forged user identity. At this time, the data packet is discarded, and malicious information is reported. Otherwise, the data packet passes authentication. Since this embodiment strongly binds user identity information with IP addresses, completion of this step means simultaneous achievement of source address verification and user identity authentication.

### Mode 2: Cross Non-Cooperative Domain Authentication:

When a data packet needs to traverse from source cooperative domain CSS through several non-cooperative domains NCS and finally arrive at destination cooperative domain CSa, the boundary routers of the two cooperative domains need to coordinate their work. The process of forwarding data packets to NCS is similar to the communication initiation phase. The difference is that since no symmetric key has been negotiated between the exit router in CSs and the next-hop device in NCS, SK cannot be found through the next-hop MAC address. Therefore, only the global group key negotiated in the system initialization phase can be used to encrypt user identity information. After encryption is completed, ICC is calculated, and authentication-required information is embedded into the data packet. Finally, an item is randomly selected from MACList as the data packet's source MAC address, and then the data packet is forwarded to NCS. Network devices within NCS neither authenticate data packets nor modify additional information in data packets; they only perform conventional routing and forwarding based on destination addresses. It should be noted that the ICC in data packets sent by the CSs' exit router to NCS no longer needs to include link address verification, because regardless of whether link addresses hop, the source MAC address will change during transmission within NCS, and the MAC address used by CSs can no longer be obtained when the data packet arrives at CSa.

When the entry router of CSa receives data packets forwarded by NCS, it first performs integrity verification by performing one hash operation on the network address, additional information other than ICC, and payload in the data packet, and then comparing the result with the ICC field carried in the data packet. If the results are inconsistent, it is considered that the data packet has been tampered with and should be discarded; otherwise, it is considered to have passed integrity verification.

Subsequently, the entry router of CSa no longer matches the corresponding MACList based on the previous-hop MAC address, but instead uses the global group key to decrypt AID, and then determines the user's true identity through the distributed infrastructure.

### EXAMPLE ILLUSTRATIONS

### Example 1

Application of this embodiment within a single cooperative domain:
\textcircled{1} The system first performs initialization. Users in the terminal group send requests to the registration server for legitimate registration to obtain necessary user identity information and MACList, and then negotiate a symmetric key with the boundary router through a secure channel.
\textcircled{2} When users send data packets attempting to enter the core network, they first find the symmetric key based on the boundary router's MAC address. After finding the symmetric key, they use it to encrypt anonymous identity information, then embed it into the source IP address part of the data packet, randomly select an item from MACList as the data packet's source MAC address, calculate ICC, and send it to the boundary router.
\textcircled{3} The boundary router first verifies ICC. After confirming that the data packet has not been tampered with, it finds the symmetric key used to encrypt the identity information of the data packet based on the source MAC address always in the data packet and performs decryption to obtain the sender's user identity privacy information, then verifies the authenticity of the user identity from the infrastructure server. The specific authentication process has been detailed in the above embodiment scheme and will not be repeated here.

### Example 2

Application of this embodiment in cross-cooperative domain communication:
\textcircled{1} The system first performs initialization, negotiating a global group key between the exit router of the source cooperative domain and the entry router of the destination cooperative domain. Users in the terminal group send requests to the registration server for legitimate registration to obtain necessary user identity information and MACList, and then negotiate a symmetric key with the boundary router in their respective domains through a secure channel.
\textcircled{2} Users send data packets attempting to traverse non-cooperative domains. After symmetric key encryption and executing the detailed process described in the above embodiment scheme, they arrive at the exit router of their domain. To coordinate work with the destination cooperative domain, the exit router encrypts user identity information using the global group key and then sends the data packet to the non-cooperative domain.
\textcircled{3} The additional information of the data packet does not hop during the process of traversing the non-cooperative domain. After arriving at the entry router of the destination cooperative domain, the entry router decrypts the identity information through the global group key and then judges the authenticity of the user identity. The specific authentication process has been detailed in the above embodiment scheme and will not be repeated here.

### Example 3

Application of this embodiment when an attacker forges identity information:
\textcircled{1} The system first performs initialization. Users in the terminal group and third-party attackers both send requests to the registration server for legitimate registration to obtain necessary user identity information and MACList, and then negotiate a symmetric key with the boundary router through a secure channel.
\textcircled{2} The third-party attacker encrypts forged fake identity information and modifies the source address information of sent data packets. After the boundary router receives it, it decrypts through the previous-hop address and verifies through the infrastructure server. The infrastructure server returns that the user identity information does not exist, so the boundary router immediately discards the data packet and reports error information. The specific authentication process has been detailed in the above embodiment scheme and will not be repeated here.

### Example 4

Application of this embodiment when an attacker tampers with data packets:
\textcircled{1} The system first performs initialization. Users in the terminal group send requests to the registration server for legitimate registration to obtain necessary user identity information and MACList, and then negotiate a symmetric key with the boundary router through a secure channel. Third-party attackers do not affect symmetric key negotiation during this phase.
\textcircled{2} Users send data packets attempting to enter the core network. After address hopping and ICC calculation, data packets carrying privacy information are sent to the network for transmission and are captured by third-party attackers. Third-party attackers modify some fields in the data packet but do not modify the source address information, then forward it to the boundary router.
\textcircled{3} The boundary router performs integrity verification and discovers that the ICC calculated based on data packet information is inconsistent with the ICC carried by the data packet itself, discards the data packet, and reports errors to the infrastructure server. The specific authentication process has been detailed in the above embodiment scheme and will not be repeated here.

The lightweight address tag framework designed in this embodiment directly modifies source addresses to make them appear as hop-by-hop random changes, thereby hiding user privacy information and enabling incremental deployment on existing network architectures, increasing deployability. The strong binding relationship between network layer addresses and user identities can simultaneously meet the requirements of identity authentication and source address authentication, enhancing system security.

The use of authentication methods in cross non-cooperative domain scenarios in this embodiment improves the system's ability to adapt to different scenarios.

The above description is only for preferred specific embodiments of this disclosure, but the protection scope of this disclosure is not limited thereto. Any person familiar with this technical field can easily conceive changes or substitutions within the technical scope disclosed in this disclosure, which should be covered within the protection scope of this disclosure. Therefore, the protection scope of this disclosure should be based on the protection scope of the claims.

What is claimed is:

1. A method for cross non-cooperative domain identity authentication, comprising:
step S1: utilizing adjacent routers within the same autonomous domain in a core network to negotiate first symmetric keys for each router and corresponding MAC address lists, utilizing boundary routers within each cooperative domain in the core network to negotiate global group keys, completing system initialization;
step S2: after system initialization is completed, performing validity verification on network-accessing users sending identity registration requests through an registration server in the core network; after verification passes, utilizing the registration server to generate digital identity identifiers and anonymized identity identifiers corresponding to the network-accessing users, and configuring MAC address lists for the network-accessing users; utilizing the registration server to construct mapping relationships among the digital identity identifiers, anonymized identity identifiers, and the MAC address lists, saving the constructed mapping relationships to distributed infrastructure in the core network and sending them to the network-accessing users, completing user identity registration;
step S3: after user identity registration is completed, the network-accessing users performing symmetric key negotiation with adjacent routers within the corresponding autonomous domain to generate second symmetric keys, and associating the second symmetric keys with the MAC address lists of the network-accessing users;
step S4: after association is completed, the network-accessing users obtaining MAC information of adjacent nodes based on a neighbor discovery protocol, determining third symmetric keys based on the obtained MAC information, encrypting the anonymized identity identifiers using an address hopping engine in the network-accessing users combined with the third symmetric keys to obtain privacy information and embedding the privacy information into source IP addresses of data packets, randomly selecting MAC addresses from the MAC address lists of the network-accessing users as source MAC addresses of the data packets, calculating integrity check codes of the data packets through hash algorithms, and embedding the integrity check codes into the data packets, completing construction of the data packets;
step S5: uploading the data packets to various routers in the core network, performing intra-cooperative domain authentication and cross non-cooperative domain authentication on the data packets during the uploading process.

2. The method for cross non-cooperative domain identity authentication according to claim 1, wherein the step S1 comprises:
step S11: negotiating the first symmetric keys between adjacent routers within the same autonomous domain through secure channels and key exchange protocols;
step S12: after negotiation of the first symmetric keys is completed, each router saving the first symmetric keys and the corresponding MAC address lists.

3. The method for cross non-cooperative domain identity authentication according to claim 1, wherein the step S2 comprises:
step S21: the network-accessing users submitting identity information to the registration server through a secure channel for identity registration; utilizing the registration server to verify the identity validity of the network-accessing users; when duplicate registration exists, the identity information being invalid and the registration request being rejected;
step S22: if duplicate registration does not exist, the identity information being valid; utilizing the registration server to generate digital identity identifiers and anonymized identity identifiers corresponding to the network-accessing users, and configuring MAC address lists for each interface of network-accessing user devices.

4. The method for cross non-cooperative domain identity authentication according to claim 1, wherein encrypting the anonymized identity identifiers using the address hopping engine in the network-accessing users combined with the third symmetric keys is specifically calculated by the formula:
(EID∥AVD)=E_{SK}(AID∥TS∥IP_{dst})
where EID is Embedded Identifier, AVD is Additional Validation Data, AID is anonymized identity identifier, TS is timestamp, IP_{dst} is destination network layer IP address, E_{SK} is symmetric key encryption algorithm using SK key.

5. The method for cross non-cooperative domain identity authentication according to claim 1, wherein calculating the integrity check codes of the data packets through hash algorithms comprises:
obtaining the integrity check codes of the data packets based on link addresses, network addresses, additional information, and payloads of the data packets, combined with hash operations.

6. The method for cross non-cooperative domain identity authentication according to claim 1, wherein the intra-cooperative domain authentication in the step S5 comprises:
when a router within a single cooperative domain receives the data packet, performing integrity verification on the integrity check code of the data packet; after integrity verification passes, finding the corresponding third symmetric key according to the source MAC address of the data packet; if the third symmetric key is not found, sending error information to the distributed infrastructure; if the third symmetric key is found, decrypting the anonymized identity identifier and destination IP address based on the obtained third symmetric key, comparing the destination IP address of the data packet with the decrypted IP address, and utilizing the distributed infrastructure to perform authenticity verification on the decrypted anonymized identity identifier and corresponding source IP address; if the destination IP address is inconsistent or the anonymized identity identifier cannot be queried in the distributed infrastructure, discarding the data packet and reporting malicious information; if the destination IP address is consistent and the anonymized identity identifier is queried in the distributed infrastructure, passing authenticity verification and completing identity authentication.

7. The method for cross non-cooperative domain identity authentication according to claim 6, wherein performing integrity verification on the integrity check code of the data packet comprises:
calculating a current integrity check code of the data packet based on hash operations; if the current integrity check code is consistent with an original integrity check code of the data packet, passing integrity verification; if the current integrity check code is inconsistent with the original integrity check code of the data packet, discarding the data packet.

8. The method for cross non-cooperative domain identity authentication according to claim 1, wherein the cross non-cooperative domain authentication in the step S5 comprises:
when the data packet traverses from a source cooperative domain through several non-cooperative domains and finally arrives at a destination cooperative domain, utilizing the global group key to encrypt user identity information to obtain privacy information and embedding the privacy information into the source IP address of the data packet, randomly selecting a MAC address from the MAC address list of the network-accessing user as the source MAC address of the data packet, calculating the integrity check code of the data packet through hash algorithms, and embedding the integrity check code into the data packet, uploading the data packet to the non-cooperative domain;
when the destination cooperative domain receives the data packet, performing integrity verification on the integrity check code of the data packet; after integrity verification passes, finding the corresponding global group key according to the source MAC address of the data packet; if the global group key is not found, sending error information to the distributed infrastructure; if the global group key is found, decrypting the anonymized identity identifier and destination IP address based on the obtained global group key, comparing the destination IP address of the data packet with the decrypted IP address, and utilizing the distributed infrastructure to perform authenticity verification on the decrypted anonymized identity identifier and corresponding source IP address; if the destination IP address is inconsistent or the anonymized identity identifier cannot be queried in the distributed infrastructure, discarding the data packet and reporting malicious information; if the destination IP address is consistent and the anonymized identity identifier is queried in the distributed infrastructure, passing authenticity verification and completing identity authentication.
